(19) United States
(12) Patent Application Publication
(10) Pub. No.: US 2025/0234311 A1
(43) Pub. Date: Jul. 17, 2025

(54) TIMING INFORMATION EXCHANGE IN WIRELESS LOCAL AREA NETWORKS

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Allen, TX (US); Vishnu Vardhan Ratnam, Frisco, TX (US); Yue Qi, Plano, TX (US)

(21) Appl. No.: 19/012,738

(22) Filed: Jan. 7, 2025

Related U.S. Application Data
(60) Provisional application No. 63/621,396, filed on Jan. 16, 2024.
(60) Provisional application No. 63/548,708, filed on Feb. 1, 2024.

(51) Int. Cl. H04W 56/00

(52) U.S. Cl. CPC H04W 56/001

(57) ABSTRACT

An electronic apparatus comprises a memory and a processor operably coupled to the memory and supporting a first non-AP station. The electronic apparatus generates timing information indicating when a packet is expired and transmits the packet to a first access point (AP) which the first non-AP station is associated with. The electronic apparatus transmits the timing information to the first AP. The timing information enables the first AP to transmit the packet based on the timing information to a second non-AP station associated with the first AP or enables the first AP to transmit the packet based on the timing information to a second AP so that the second AP transmits the packet to a third non-AP station associated with the second AP.

### CROSS-REFERENCE TO RELATED APPLICATIONS

This application claims the benefit of priority from U.S. Provisional Application No. 63/621,396 entitled “TIMING INFORMATION EXCHANGE FOR END TO END SUPPORT IN NEXT GENEARTION WLANS,” filed Jan. 16, 2024; and U.S. Provisional Application No. 63/548,708 entitled “TIMING INFORMATION SHARING FOR MULTI-AP NETWORKS,” filed Feb. 1, 2024, all which are incorporated herein by reference in their entirety.

### TECHNICAL FIELD

This disclosure relates generally to a wireless communication system, and more particularly to, for example, but not limited to, timing information exchange for end-to-end support in wireless local area networks and timing information sharing for multi-AP networks.

### BACKGROUND

The ultra high reliability study group (UHR SG) is the study group for next generation Wi-Fi standards design (IEEE 802.11bn). The UHR SG has set a number of objectives for the next generation Wi-Fi network design. The group intends to achieve the ultra-high reliability target by reducing latencies to ultra-low values, increasing throughputs at different SNR levels, enhancing power savings, etc. To meet these objectives, the group intends to develop new protocols and concepts for performance improvement compared to Wi-Fi 7.

Some of the new applications that the UHR group has considered to provide support for in next generation Wi-Fi networks are shown in Table 1. Table 1 shows example applications with ultra-low latency requirements. Specifically, for each application category, Table 1 shows the requirements in terms of intra basic service set (BSS) latency which is the time to transmit a frame from the AP to the STA or vice versa, the jitter variance, packet loss and data rate (Mbps).

TABLE 1

| | | Intra | | | |
|---|---|---|---|---|---|
| | | BSS | Jitter | | |
| | | latency | variance | Packet | Data rate |
| Use cases | | (ms) | (ms) | loss | (Mbps) |
| Real-time gaming | | <5 | <2 | <0.1% | <1 |
| Cloud gaming | | <10 | <2 | Near-lossless | <0.1 |
| | | | | | (Reverse link) |
| | | | | | >5 Mbps |
| | | | | | (Forward link) |
| Real-time video | | <3~10 | <1~2.5 | Near-lossless | 100~28,000 |
| Robotics | Equipment | <1~10 | <0.2~2 | Near-lossless | <1 |
| and | control | | | | |
| industrial | Human | <1~10 | <0.2~2 | Near-lossless | <1 |
| auto- | safety | | | | |
| mation | Haptic | <1~5 | <0.2~2 | Lossless | <1 |
| | technology | | | | |
| | Drone | <100 | <10 | Lossless | <1 |
| | control | | | | >100 |
| | | | | | with video |

There has been an increasing demand for Wi-Fi connectivity in indoor environments. In order to fulfill this need, network managers deploy multiple access points (APs) indoors to meet end user needs. These co-deployed APs typically employ limited forms of coordination for various network functionalities. As a result, there may be interference from neighboring BSS which can impact the end user experience. In order to minimize the impact to end user experience from multi-AP operation, multi-AP coordination is under consideration for next generation Wi-Fi networks.

The description set forth in the background section should not be assumed to be prior art merely because it is set forth in the background section. The background section may describe aspects or embodiments of the present disclosure.

### SUMMARY

The present disclosure is directed to improvements in wireless communication. In particular, the present disclosure is directed to reduction of latencies in the wireless communication.

In some embodiments, an electronic apparatus comprises a memory; and a processor operably coupled to the memory and supporting a first non-AP station. The processor is configured to cause: generating timing information indicating when a packet is expired, transmitting the packet to a first access point (AP) which the first non-AP station is associated with, and transmitting the timing information to the first AP to enable the first AP to transmit the packet based on the timing information to a second non-AP station associated with the first AP or to enable the first AP to transmit the packet based on the timing information to a second AP so that the second AP transmits the packet to a third non-AP station associated with the second AP.

In some embodiments, the timing information includes at least one of enqueue time indicating a time at which the packet is placed into a queue, a queuing delay indicating a time which the packet spends waiting in a queue before being transmitted, head-of-line (HOL) timing information indicating a time at which the packet reached the head of a queue, an expiration time indicating when the packet is expired, an expiration timer indicating time intervals after which the frame can be considered to be expired, and an information item indicating the amount of time after which the frame can be considered to be expired.

In some embodiments, wherein the processor is further configured to cause: receiving a solicitation message to request the timing information from the first AP, and transmitting the timing information to the first AP in response to the request.

In some embodiments, the solicitation message includes at least one of an information item indicating a traffic stream for which the timing information is being requested, an information item indicating a traffic category for which the timing information is being requested, an information item indicating a time window over which the timing information can be collected, an information item indicating that raw timing information is being requested instead of a cumulative statistic timing information, an information item indicating a reason for requesting the timing information, an information item indicating a dialog token serving as a reference of the solicitation message, and an information item indicating a device which is requested to provide the timing information.

In some embodiments, the processor is further configured to cause: receiving capability information indicating whether the first AP is able to process the packet based on the timing information, from the first AP.

In some embodiments, the processor is further configured to cause: transmitting capability information indicating whether the electronic apparatus is able to provide the timing information, to the first AP.

In some embodiments, the processor is further configured to cause: transmitting a need indication message including a need indication requesting the first AP to process a packet transmitted by the electronic apparatus based on the timing information, to the first AP.

In some embodiments, the need indication message further includes at least one of an information item indicating a duration for which processing indicated by the need indication is needed, an information item indicating a device for which processing indicated by the need indication is needed, an information item indicating traffic stream for which processing indicated by the need indication is needed, and an information item indicating traffic category for which processing indicated by the need indication is needed.

In some embodiments, the packet and the timing information is included in the same frame.

In some embodiments, the timing information and the packet are transmitted in separate frames.

In some embodiments, a method performed by an electronic apparatus including a first non-access-point (non-AP) station, comprises: generating timing information indicating when a packet is expired; transmitting the packet to a first access point (AP) which the first non-AP station is associated with; and transmitting the timing information to the first AP to enable the first AP to transmit the packet based on the timing information to a second non-AP station associated with the first AP or to enable the first AP to transmit the packet based on the timing information to a second AP so that the second AP transmits the packet to a third non-AP station associated with the second AP.

In some embodiments, the timing information includes at least one of enqueue time indicating a time which the packet is placed into a queue, a queuing delay indicating a time which the packet spends waiting in a queue before being transmitted, head-of-line (HOL) timing information indicating a time at which the packet reached the head of a queue, an expiration time indicating when the packet is expired, an expiration timer indicating time intervals after which the frame can be considered to be expired, and an information item indicating the amount of time after which the frame can be considered to be expired.

In some embodiments, the method further comprises: receiving a solicitation message to request the timing information from the first AP, and wherein the timing information is transmitted to the first AP in response to the request.

In some embodiments, the solicitation message includes at least one of an information item indicating a traffic stream for which the timing information is being requested, an information item indicating a traffic category for which the timing information is being requested, an information item indicating a time window over which the timing information can be collected, an information item indicating that raw timing information is being requested instead of a cumulative statistic timing information, an information item indicating a reason for requesting the timing information, an information item indicating a dialog token serving as a reference of the solicitation message, and an information item indicating a device which is requested to provide the timing information.

In some embodiments, the method of claim 11 further comprises: receiving capability information indicating whether the first AP is able to process the packet based on the timing information, from the first AP.

In some embodiments, the method further comprises: transmitting capability information indicating whether the electronic apparatus is able to provide the timing information, to the first AP.

In some embodiments, the method further comprises: transmitting a need indication message including a need indication requesting the first AP to process a packet transmitted by the electronic apparatus based on the timing information, to the first AP.

In some embodiments, the need indication message further includes at least one of an information item indicating a duration for which processing indicated by the need indication is needed, an information item indicating a device for which processing indicated by the need indication is needed, an information item indicating traffic stream for which processing indicated by the need indication is needed, and an information item indicating traffic category for which processing indicated by the need indication is needed.

In some embodiments, the packet and the timing information is included in the same frame.

In some embodiments, the timing information and the packet are transmitted in separate frames.

### BRIEF DESCRIPTION OF THE DRAWINGS

FIG. 1 shows an example of a wireless network in accordance with an embodiment.

FIG. 2 shows an example of an AP in accordance with an embodiment.

FIG. 3 shows an example of a STA in accordance with an embodiment.

FIG. 4 shows an example of end-to-end communication in the same BSS in accordance with an embodiment.

FIG. 5 shows an example of end-to-end communication in the same operational domain in accordance with an embodiment.

FIG. 6 shows an example problem for the same BSS scenario in accordance with an embodiment.

FIG. 7 shows an example problem for the same operational domain scenario in accordance with an embodiment.

FIG. 8 shows an example operation in the same BSS scenario in accordance with an embodiment.

FIG. 9 shows an example operation in the same operational domain scenario.

FIG. 10 shows an example solicitation of the timing information in accordance with an embodiment.

FIG. 11 shows an exemplary capability advertisement for the timing information in accordance with an embodiment.

FIG. 12 shows an exemplary need indication for the timing information in accordance with an embodiment.

FIG. 13 shows operations of devices in the multi-AP network in accordance with an embodiment.

In one or more implementations, not all the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

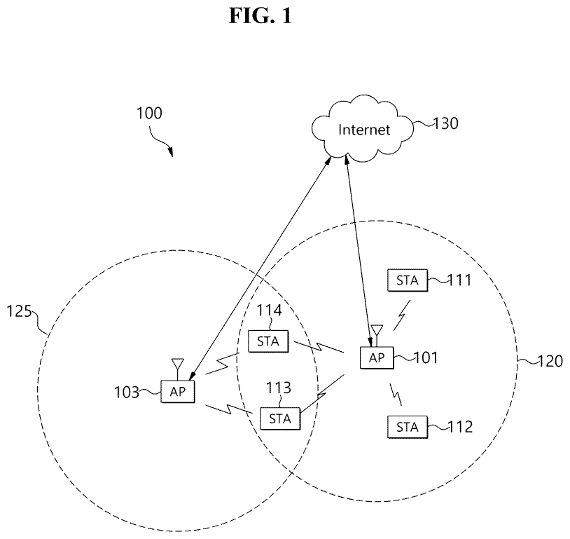

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage area 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

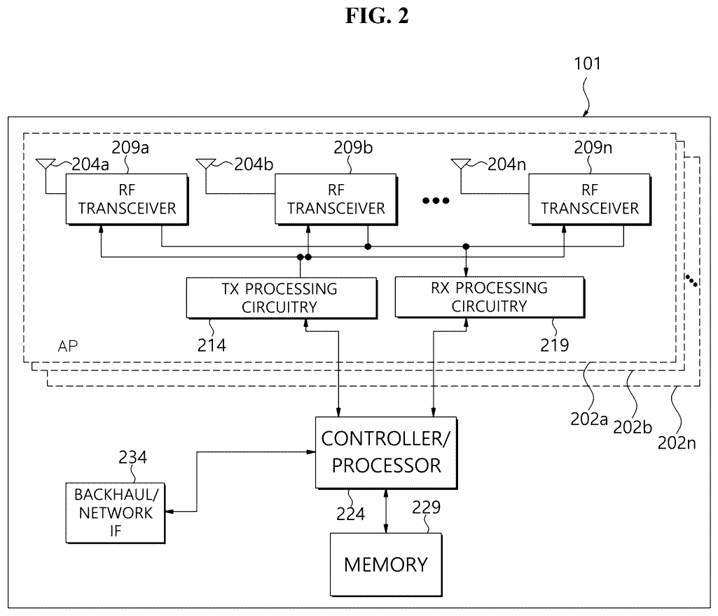

FIG. 2 shows an example of AP 101 in accordance with an embodiment. The embodiment of the AP 101 shown in FIG. 2 is for illustrative purposes, and the AP 103 of FIG. 1 could have the same or similar configuration. However, APs come in a wide range of configurations, and FIG. 2 does not limit the scope of this disclosure to any particular implementation of an AP.

As shown in FIG. 2, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2 illustrates one example of AP 101, various changes may be made to FIG. 2. For example, the AP 101 could include any number of each component shown in FIG. 2. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2 could be combined, further subdivided, or omitted and additional components could be added according to particular needs.

As shown in FIG. 2, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2 shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

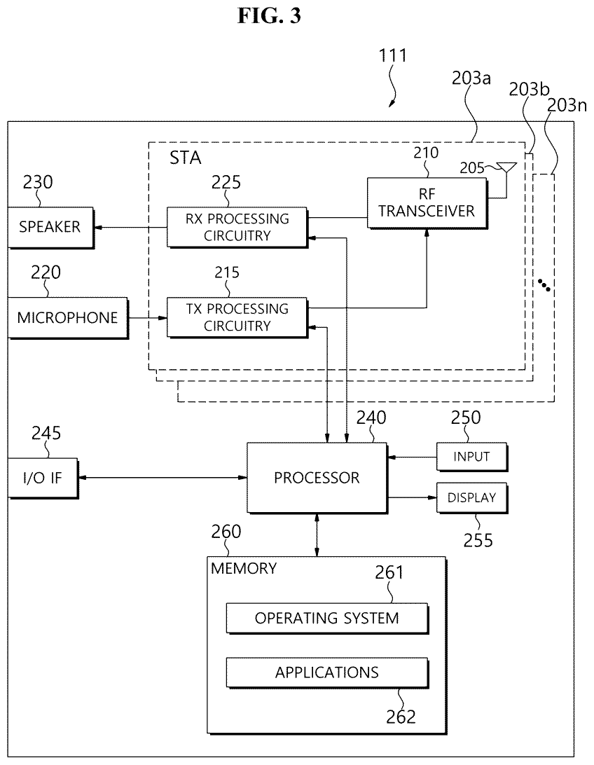

FIG. 3 shows an example of STA 111 in accordance with an embodiment. The embodiment of the STA 111 shown in FIG. 3 is for illustrative purposes, and the STAs 111-114 of FIG. 1 could have the same or similar configuration. However, STAs come in a wide variety of configurations, and FIG. 3 does not limit the scope of this disclosure to any particular implementation of a STA.

As shown in FIG. 3, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 3 shows one example of STA 111, various changes may be made to FIG. 3. For example, various components in FIG. 3 could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 3 illustrates the STA 111 configured as a mobile telephone or smartphone, STAs could be configured to operate as other types of mobile or stationary devices.

As shown in FIG. 3, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 3 shows that each STA 203a-203n has a separate antenna, but each STA 203a-203n can share the antenna 205 without needing separate antennas. Each STA 203a-203n may represent a physical (PHY) layer and a lower media access control (MAC) layer.

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11be/D3.2, “Wireless LAN Medium Access Control (MAC) and Physical Layer (PHY) Specifications” (hereinafter, collectively “the Standard”).

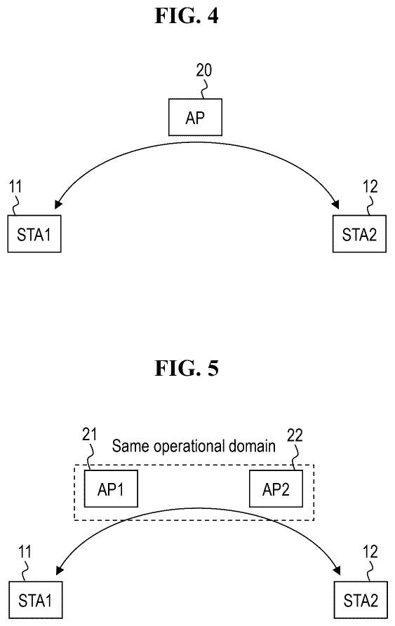

Hereinafter, an end-to-end support will be described with reference to FIG. 4 and FIG. 5.

FIG. 4 shows an example of end-to-end communication in the same BSS in accordance with an embodiment.

As shown in FIG. 4, the first non-AP station 11 and the second non-AP station 12 may be associated with the same AP station 20 and located in the same BSS created by the AP station 20. The non-AP stations 11 and 12 may communicate with each other through the AP station 20.

FIG. 5 shows an example of end-to-end communication in the same operational domain in accordance with an embodiment.

As shown in FIG. 5, non-AP stations 11 and 12 may be associated with the AP stations 21 and 22, respectively. The AP stations 21 and 22 may be located in the same operational domain. For example, the AP stations 21 and 22 may be located in the same mobility domain, the same extended service set (ESS), or with inter-AP communication capability.

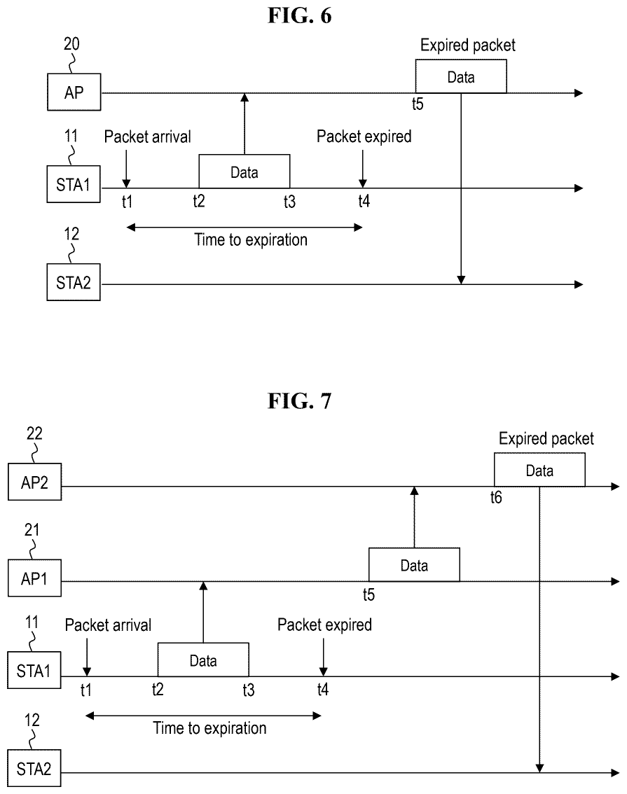

Referring to FIG. 4 and FIG. 5, in addition to delay tolerance for downlink or uplink transmissions, some ultra-low latency applications such as extended reality (XR) applications may have end-to-end delay tolerance as well. In such scenarios, lack of timing information availability at the AP side can cause an inefficiency in transmission as well as wastage of resources. Such inefficiency will be described with reference to FIG. 6 and FIG. 7.

FIG. 6 shows an example problem for the same BSS scenario in accordance with an embodiment.

Specifically, FIG. 6 shows an example wireless communication in the context of the scenario shown in FIG. 4.

Referring to FIG. 6, an event-based packet arrives at the first non-AP station 11 at time t1. The packet may have an expiration time when the packet is expired depending on the end-to-end latency of the packet. As shown in FIG. 6, the first non-AP station 11 sends the packet to the AP station 20 at time t2 and the AP station 20 completes the reception of the packet at time t3. Upon reception of the packet, the AP station 20 may transmit the packet to the second non-AP station 12 at time t5. However, even if the AP station 20 is aware of the end-to-end latency of the traffic stream which the packet corresponds to, the AP station 20 may not be aware of the total elapsed time or the total delay caused by various reasons such as queuing delays due to other traffic streams from the first non-AP station 11 and channel access delay, which is the time taken from when the packet is enqueued at the first non-AP station 11 until the packet arrives at the AP station 20. Thus, the AP station 20 cannot compute the expiration time for the packet without additional information. In this scenario, the AP station 20 may not schedule the packet for transmission in time and end up transmitting an expired packet leading to wastage of airtime. For example, as shown in FIG. 6, even if the packet become expired at time t4, the AP station 20 may not be aware of it. Since the AP station 20 may not prioritize the packet because of ignorance of the expiration time, the AP station 20 may transmit the expired packet to the second non-AP station 12 at time t5 after the packet already expires, which causes inefficiency in transmission as well as wastage of resources.

FIG. 7 shows an example problem for the same operational domain scenario in accordance with an embodiment.

Inefficiency in transmission may happen in the same operational domain scenario.

As shown in FIG. 7, an event-based packet arrives at the first non-AP station 11 at time t1. The packet may have an expiration time when the packet is expired depending on the end-to-end latency of the packet. The first non-AP station 11 sends the packet to the first AP station 21 at time t2 and the AP station 21 completes the reception of the packet at time t3. Upon reception of the packet, the AP station 21 may transmit the packet to the second AP station 22 at t5. However, even if the AP station 21 is aware of the end-to-end latency of the traffic stream which the packet corresponds to, the AP station 21 may not be aware of the total elapsed time or the total delay caused by various reasons such as queuing delays due to other traffic streams from the first non-AP station 11 and channel access delay, which is the time taken from when the packet is enqueued at the first non-AP station 11 until the packet arrives at the AP station 21. Thus, the AP station 21 cannot compute the expiration time for the packet without additional information. In this scenario, the AP station 21 may not schedule the packet for transmission in time and end up transmitting an expired packet leading to wastage of airtime. For example, as shown in FIG. 7, even if the packet become expired at time t4, the AP station 21 may not be aware of it. Since the AP station 21 may not prioritize the packet because of ignorance of the expiration time, the AP station 21 may transmit the expired packet to the AP station 22 at time t5 after the packet already expires. Furthermore, the second AP station 22 also may not know that the packet already expires and it may transmit the expired packet to the second non-AP station 12, which causes inefficiency in transmission as well as wastage of resources.

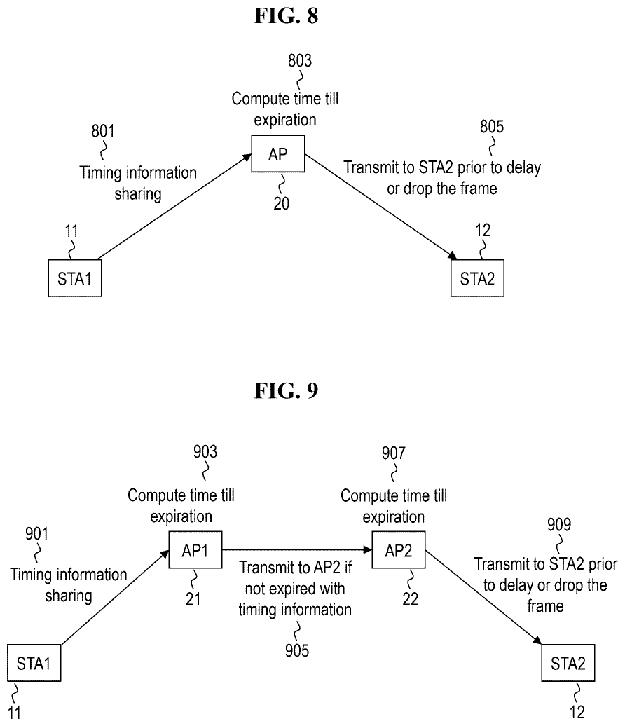

Hereinafter, the end-to-end support in accordance with various embodiments will be described with reference to FIG. 8 and FIG. 9.

FIG. 8 shows an example operation in the same BSS scenario in accordance with an embodiment.

Referring to FIG. 8, the first non-AP station 11 may share timing information with the AP station 20 by providing the timing information to the AP station 20 at 801 to enable the AP station 20 to compute an expiration time of a packet and transmit the packet to the second non-AP station 12 before the expiration time. In some embodiments, the timing information may indicate when the packet is expired. For example, the timing information may indicate when the packet can be expired in the future and/or when the packet has already been expired. In some embodiments, the expiration time of the packet may represent a time after which the packet can be considered to be expired. In some embodiments, the first non-AP station 11 may provide the timing information to its associated AP station 20 to enable the AP station 20 to compute the time to expiration for the frames being transmitted to STA2. The timing information will be detailed with reference to Table 2.

Upon receiving the timing information from the first non-AP station 11, the AP station 20 may compute the expiration time based on the timing information, at 803.

The AP station 20 may process the packet based on the timing information at 805. In some embodiments, the AP station 20 may transmit the packet to the second non-AP station 12 if it determines that the expiration time has not arrived or that the packet can be transmitted in time before the expiration time. In some embodiments, the AP station 20 may prioritize the transmission of the packet to the second non-AP station 12, for example, by prioritizing the frames that are closer to transmission, at 805. In some embodiments, if the AP station 20 is unable to transmit the frame before the expiration time, it may drop the frame to avoid wastage of airtime caused by transmission of an expired frame. In some embodiments, the AP station 20 may assess whether the frame can be transmitted in time before the expiration time and drop the frame based on the assessment before the expiration time. In some embodiment, the AP station 20 may retain the frame until expiration time and then may drop the frame when the expiration time arrives.

Table 2 shows example information items that can be used to convey the timing information.

TABLE 2

| Information | |
|---|---|
| item | Description |
| Enqueue | This information item may indicate the enqueue timing. |
| timing | For example, this information item may include an |
| information | enqueue time indicating the time at which a data packet |
| | is placed into a queue. This enqueue timing information |
| | may be shared for one or more frames. For example, it |
| | may be indicated for the head-of-line (HOL) packet |
| | which refers to the first packet in a queue that is |
| | waiting to be transmitted or processed. |
| Queuing | This information item may indicate the queuing delay |
| delay | information. For example, this information item may |
| information | include a queuing delay which refers to the time which |
| | a packet spends waiting in a queue before i tcan be |
| | transmitted over a network. This information may be |
| | shared for one or more frames. For Example, it may be |
| | indicated for the HOL packet. |
| HOL timing | This information item may indicate the time at which a |
| information | frame reached the head of the line. For example, this |
| | information item may include an HOL time at which a |
| | frame reached the head of a queue. This timing |
| | information may also be shared for one or more frames. |
| Expiration | This information item may indicate the expiration timing |
| timing | information. For example, this information item may |
| information | include an expiration time indicating when a frame is |
| | expired. This timing information may be shared for one |
| | or more frames. For example, it may be indicated for |
| | the HOL packet. |
| Timer | This information item may indicate one or more timers, |
| information | instead of time, to enable the AP to assess if the frame |
| | has expired or not. For example, this information item |
| | may include an expiration timer indicating time intervals |
| | after which the frame can be considered to be expired. |
| | This timing information can be shared for one or more |
| | frames. For example, it may be indicated for the HOL |
| | packet. |
| Delay | This information item may indicate the amount of time |
| bound | after which the frame can be considered to be expired. |
| information | For example, this information item may include a |
| | delay bound value. This timing information can be |
| | shared for one or more frames. For example, it may be |
| | indicated for the HOL packet. |
| Worst case | This information item may describe the worst case |
| timing | timing information. For example, this information |
| information | item may include an enqueue time for the frame |
| | that has stayed in the queue for the longest period of |
| | time or the HOL frame, the expiry time for the |
| | frame that has the earliest expiration time, etc. |
| Average | This information item may describe the average timing |
| timing | information. For example, this information item may |
| information | include the average queuing delay for all the frames |
| | in that transmission. |
| Best case | This information item may describe the best case |
| timing | timing information. For example, this information |
| information | item may include the best case queuing |
| | delay across all the frames in that transmission. |
| Variation | This information item may describe the variation for |
| information | various timing information across all the frames in the |
| | transmission. For example, this information item may |
| | include a variation for queuing delay computed over |
| | all the frames in that transmission. |
| Timing | This information item may describe the timing |
| information | information over the past transmissions for the same |
| based on | category of frames. For example, this information |
| past data | item may include average and/or best and/or worst case |
| | queuing delay across all the frames transmitted in that |
| | category in the past. Any of the above metrics may |
| | also be used instead of queuing delay. |
| Measurement | This information item may describe the window over |
| window | which the timing information can be collected. This |
| | measurement window may also be negotiated between |
| | the two devices beforehand or can be a predetermined |
| | value. For example, the predetermined value may be |
| | fixed by the specification. |

In some embodiments, the above information items shown in Table 2 may be transmitted together or separately. In some embodiments, they may be transmitted as a part of any existing frame/element/field/subfield in the Standard or may be a part of newly defined ones.

In some embodiments, to generalize the embodiments, the first non-AP station 11, the AP station 20, and the second non-AP station 12 shown in FIG. 8 may be referred to as first, second, and third devices, respectively. In some embodiments, the first non-AP station 11 and the second non-AP station 12 may be the same device.

FIG. 9 shows an example operation in the same operational domain scenario.

Referring to FIG. 9, the first non-AP station 11 may share timing information with the AP station 21 by providing the timing information to the AP station 21 at 901 to enable the AP station 21 to compute an expiration time of a packet and transmit the packet to the second non-AP station 12 before the expiration time. In some embodiments, the first non-AP station 11 may provide the timing information to its associated AP station 21 to enable the AP station 21 to compute the time to expiration for the frames being transmitted to STA2.

Upon receiving the timing information from the first non-AP station 11, the AP station 21 may compute the expiration time based on the timing information from the first non-AP station 11, at 903.

The first AP station 21 may process the packet based on the timing information at 905. In some embodiments, the first AP station 21 may transmit the packet along with timing information for the packet to the second AP station 21 if it determines that the expiration time has not arrived or that the packet can be transmitted in time before the expiration time. In some embodiments, the AP station 21 may prioritize the transmission of the packet to the second AP station 21, for example, by prioritizing the frames that are closer to transmission. In some embodiments, if the AP station 21 is unable to transmit the frame before the expiration time, it may drop the frame to avoid wastage of airtime caused by transmission of an expired frame. In some embodiments, the AP station 21 may assess whether the frame can be transmitted in time before the expiration time and drop the frame based on the assessment before the expiration time. In some embodiment, the AP station 21 may retain the frame until expiration time and then may drop the frame when the expiration time arrives.

Upon receiving the timing information from the first AP station 21, the second AP station 22 may compute the expiration time based on the timing information from the first AP station 21, at 907.

The second AP station 22 may process the packet based on the expiration time at 909. In some embodiments, the second AP station 22 may transmit the packet to the second non-AP station 12 if it determines that the expiration time has not arrived or that the packet can be transmitted in time before the expiration time. In some embodiments, the second AP station 22 may prioritize the transmission of the packet to the second non-AP station 12, for example, by prioritizing the frames that are closer to transmission. In some embodiments, if the second AP station 22 is unable to transmit the frame before the expiration time, it may drop the frame to avoid wastage of airtime caused by transmission of an expired frame. In some embodiments, the second AP station 22 may assess whether the frame can be transmitted in time before the expiration time and drop the frame based on the assessment before the expiration time. In some embodiment, the second AP station 22 may retain the frame until expiration time and then may drop the frame when the expiration time arrives.

In some embodiments, to generalize the embodiments, the first non-AP station 11, the first AP station 21, the second AP station 22, and the second non-AP station 12 shown in FIG. 9 may be referred to as first, second, third, and fourth devices, respectively. In some embodiments, the first non-AP station 11 and the second non-AP station 12 may be the same device. The transmitter of the timing information may also be the second or the third device instead of the first device.

Hereinafter, the solicitation of the timing information will be described.

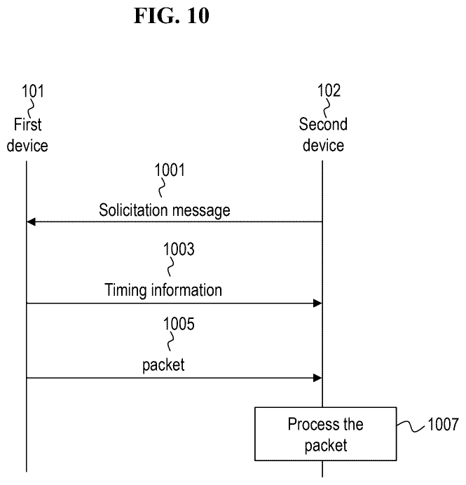

The above timing information may either be shared in an unsolicited manner or may be shared upon request. In some embodiments, the non-AP station may provide the timing information for each transmitted frame or each transmission. In some embodiments, the AP station may request the timing information from the non-AP station by sending a solicitation message. The solicitation of the timing information will be described with reference to FIG. 10.

FIG. 10 shows an example solicitation of the timing information in accordance with an embodiment.

In some embodiments, the first device 101 and the second device 102 may be the non-AP station and the AP station as shown in FIG. 8 or FIG. 9, respectively. In some embodiments, the first device 101 and the second device 102 may be the first AP station and the second AP station as shown in FIG. 9, respectively. In some embodiments, the first device 101 and the second device 102 may be the non-AP stations.

At 1001, the second device 102 may request the first device 101 to provide timing information for at least one packet by sending a solicitation message. The solicitation message may be referred to as a request for timing information. In some embodiments, the second device 102 may send the solicitation message for the timing information before or after it receives a packet associated with the timing information from the first device 101.

At 1003, the first device 101 may transmit timing information to the second device 102 in response to the solicitation message.

At 1005, the first device 101 may transmit a packet related to the timing information to the second device 102. In some embodiments, the first device 101 may transmit a frame including both the packet and the timing information. In some embodiments, the first device 101 may transmit the packet and the timing information in separate frames. In some embodiments, the first device 101 may transmit the packet before or after it transmits the timing information.

At 1007, the second device 102 may obtain the expiration time of the packet based on the timing information and process the packet based on the expiration time, as described above.

The solicitation message may contain at least one or more of the information items as indicated in Table 3. Table 3 shows information items that can be present in the solicitation message.

TABLE 3

| Information | |
|---|---|
| item | Description |
| Traffic | This information item may indicate the traffic stream for |
| stream | which the timing information is being requested. For |
| indicator | example, this information item may include a stream |
| | classification service identifier (SCSID). |
| Traffic | This information item may indicate the traffic category |
| category | for which the timing information is being requested. For |
| indicator | example, this information item may include a traffic |
| | identifier (TID), an access category (AC), or both. |
| Measurement | This information item may indicate the time window over |
| window | which the measurements can be taken. In some |
| | embodiments, this information item may indicate a time |
| | window over which the timing information can be |
| | collected. |
| Raw timing | An information item that can indicate that the raw timing |
| information | information is being requested instead of a cumulative |
| | statistic. For example, this information item may include |
| | queuing delay instead of average/best/worst delay. |
| Reason | This information item may indicate the reason for sending |
| information | this information. For example, this information item may |
| | include a reason code. |
| Dialog token | This information item may serve as a reference for this |
| | request. For example, this information item may |
| | include a dialog token. |
| Device | This information item may indicate the device for which |
| indicator | such an indication can be provided. |

In some embodiments, the above information items shown in Table 3 may be transmitted together or separately. In some embodiments, they may be transmitted as a part of any existing frame/element/field/subfield in the Standard or may be a part of newly defined ones.

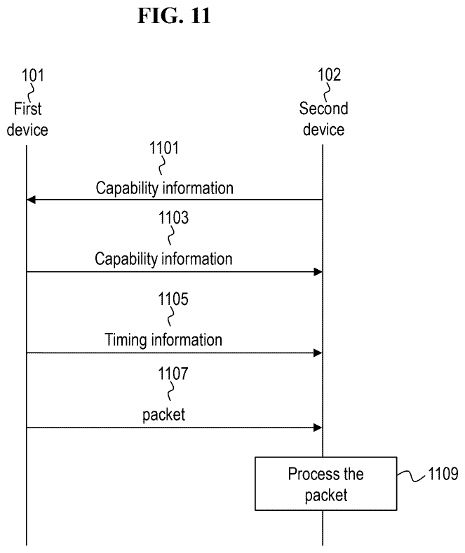

Hereinafter, the capability advertisement for the timing information will be described with reference to FIG. 11.

FIG. 11 shows an exemplary capability advertisement for the timing information in accordance with an embodiment.

In some embodiments, the first device 101 and the second device 102 may be the non-AP station and the AP station as shown in FIG. 8 or FIG. 9, respectively. In some embodiments, the first device 101 and the second device 102 may be the first AP station and the second AP station as shown in FIG. 9, respectively. In some embodiments, the first device 101 and the second device 102 may be the non-AP stations.

As shown in FIG. 11, at 1101, the second device 102, which receives one or more frames from the first device 101, may advertise its capability information. In some embodiments, the capability information may indicate a support for reception/transmission or processing of such timing information in one or more frames that the first device 102 transmits or receives. In some embodiments, the capability information may indicate whether the second device 102 can provide processing based on the timing information for one or more frames that the second device 102 receives. In some embodiments, the capability information may be carried in management frames such as beacons, probe responses, (Re)association responses. In some embodiments, the capability information may enable the first device 101 to identify if the second device 102 which the first device 101 intends to be or is associated with can provide such a timing information exchange support.

At 1103, the first device 101, which transmits one or more frames to the first device 102, may advertise its capability information. In some embodiments, the capability information may indicate a support for reception/transmission or processing of such timing information in one or more frames that the first device 101 transmits or receives. In some embodiments, the capability information may indicate whether the first device 101 can provide the timing information for one or more frames that the first device 101 transmits. In some embodiments, the capability information may be carried in management frames such as beacons, probe responses, (Re)association responses. In some embodiments, the capability information may enable the second device 102 to identify if the first device 101 which the second device 102 intends to be or is associated with can provide such a timing information exchange support.

At 1105, the first device 101 may transmit timing information to the second device 102. In some embodiments, the first device 101 may transmit timing information to the second device 102 when the capability information received from the second device 102 indicates that the second device 102 is able to provide processing based on the timing information for one or more frames that the second device 102 receives. In some embodiments, the second device 102 may transmit the solicitation message when the capability information received from the first device 101 indicates that the first device 101 is able to provide the timing information for one or more frames that the first device 101 transmits, and then the first device 101 may transmit the transmit timing information to the second device 102 in response to the solicitation message.

At 1107, the first device 101 may transmit a packet related to the timing information to the second device 102. In some embodiments, the first device 101 may transmit a frame including both the packet and the timing information. In some embodiments, the first device 101 may transmit the packet and the timing information in separate frames. In some embodiments, the first device 101 may transmit the packet before or after it transmits the timing information.

At 1109, the second device 102 may obtain the expiration time of the packet based on the timing information and process the packet based on the expiration time, as described above.

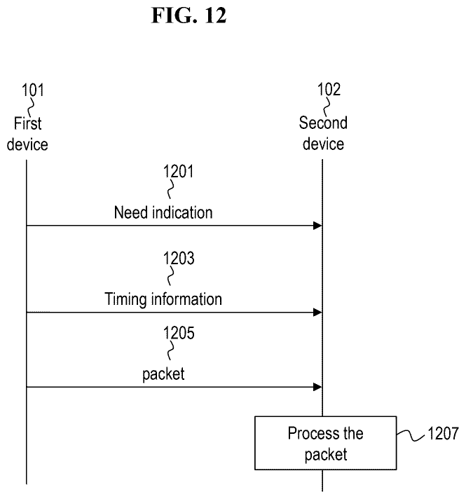

Hereinafter, the need indication for the timing information will be described with reference to FIG. 12.

FIG. 12 shows an exemplary need indication for the timing information in accordance with an embodiment.

At 1201, the first device 101 may transmit a need indication to the second device 102 to notify the second device 102 that the first device 101 needs a support for processing based on the timing information for one or more frame that the first device 101 transmits. In some embodiments, the need indication may be made when the first device 101 is transmitting to the second device 102. In some embodiments, the need indication may be made by transmission of a need indication message. In some embodiments, the need indication may be transmitted in a frame including a packet associated with the need indication or may be transmitted in a separate frame from the frame including the packet.

At 1203, the first device 101 may transmit timing information to the second device 102 in response to the solicitation message.

At 1205, the first device 101 may transmit a packet related to the timing information to the second device 102. In some embodiments, the first device 101 may transmit a frame including both the packet and the timing information. In some embodiments, the first device 101 may transmit the packet and the timing information in separate frames. In some embodiments, the first device 101 may transmit the packet before or after it transmits the timing information.

At 1207, the second device 102 may obtain the expiration time of the packet based on the timing information and process the packet based on the expiration time, as described above.

In some embodiments, the need indication may contain at least one or more of the information items as indicated in Table 4. Table 4 shows information items that can be present in the need indication message.

TABLE 4

| Information | |
|---|---|
| item | Description |
| Need | This information item may indicate the need for such |
| indication | a support. This information item may indicate a bit or |
| | a flag that can be set to a predetermined value (e.g., 1) |
| | to indicate the need. |
| Duration | This information item may indicate the duration for |
| indication | which such a support can be needed. This information |
| | item may indicate a time window. |
| Device | This information item may indicate the device(s) for |
| indicator | which such an support can be needed. This information |
| | item may indicate a STA MAC address. |
| Traffic | This information item may indicate the traffic stream |
| stream | for which the above support can be requested. This |
| indicator | information item may indicate SCSID. |
| Traffic | This information item may indicate the traffic category |
| category | for which the above information can be requested. For |
| indicator | example, this information item may include a traffic |
| | identifier (TID), an access category (AC), or both. |

In some embodiments, if during association the first device 101 such as a non-AP station has indicated the capability for such a support, then the first device 101 may provide the timing information directly without making an explicit need indication.

In some embodiments, the above information items shown in Table 4 may be transmitted together or separately. In some embodiments, they may be transmitted as a part of any existing frame/element/field/subfield in the Standard or may be a part of newly defined ones.

Even if the above embodiments are described in the context of timing information sharing for the examples described above, they may not be limited to those examples. They may be generally used wherever applicable.

Hereinafter, operations of devices in the multi-AP network will be described.

In a multi-AP network, when an AP station can share time and frequency resources with another AP station, it can be beneficial for the sharing AP to understand the timing information for the traffic that the other AP can handle. Unfortunately, there is no procedure to share timing information between APs in the current Wi-Fi standard specification. A new procedure to share timing information is thus needed. For convenience, the AP station that shares a portion of its TXOP by sharing time and frequency resources may be referred to as a sharing AP. The AP station which the sharing AP shares a portion of TXOP with may be referred to as a shared AP.

The shared AP station may share the timing information with one or more AP stations in its vicinity. The shared AP may collect such information from one or more non-AP stations which the shared AP is associated with. The shared AP may transmit a timing information sharing message to one or more APs in its vicinity. When a neighbor AP provides assistance to the shared AP, the shared AP may make use of the assistance to transmit and/or receive the relevant frames. For example, if a neighbor AP shares a portion of its TXOP with the shared AP, the shared AP may make use of that portion to transmit and/or receive the relevant frames. The shared AP may determine to send this timing information sharing message to the one or more neighboring APs based on a number of parameters such as the interference levels from the one or more neighboring APs, presence of prior agreements with the one or more neighboring APs, etc.

In some embodiments, when a neighboring AP receives timing information sharing message from the shared AP, the neighboring AP may process the message and determine if the neighbor AP can assist the shared AP in time. If the neighboring AP determines that it can provide assistance, the neighboring AP may trigger the relevant procedure to provide assistance to the shared AP. For example, if the neighboring AP determines that it can share a portion of its acquired TXOP with the shared AP in time, the neighboring AP may share the portion of the TXOP and become the sharing AP. If the neighboring AP determines that it cannot provide the assistance to the shared AP in time, the neighboring AP may either send a message making the indication to the shared AP or the neighboring AP may not send any indication. If the shared AP has shared a list of timing information, then the neighboring AP may assess if the neighboring AP can provide assistance to the shared AP before the next timing deadline in the list and try to provide assistance based on the assessment before that deadline.

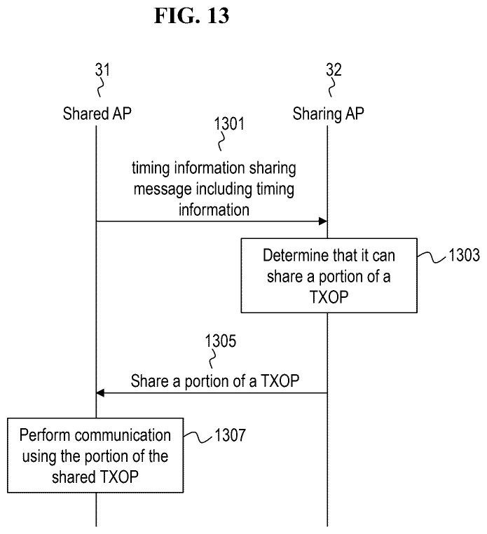

FIG. 13 shows operations of devices in the multi-AP network in accordance with an embodiment.

Referring to FIG. 13, a shared AP station 31 transmits a timing information sharing message timing information including timing information to a sharing AP station 32 at 1301. In some embodiments, the shared AP station 31 may collect timing information from one or more non-AP stations which the shared AP station 31 is associated with and may generate timing information in the timing information sharing message based on the collected timing information. The timing information in the timing information sharing message may be the same or different from the collected timing information.

At 1303, the sharing AP 32 determines, based on information in the timing information sharing message, whether it can share a portion of a TXOP which it acquired.

At 1305, if the sharing AP 32 determines that it can share a portion of its TXOP, the sharing AP 32 shares a portion of its acquired TXOP by sending a message to the shared AP 31.

At 1307, the shared AP 31 performs communication using the shared portion of the TXOP acquired by the sharing AP 32. In some information, the shared AP 31 may perform communication with one or more non-AP stations which the shared AP 31 is associated with.

In some embodiments, the timing information may be conveyed by one or more of the parameters. Examples of such parameters are shown in Table 5. Table 5 shows example parameters that can be used for conveying timing information.

TABLE 5

| Information | |
|---|---|
| item | Description |
| Enqueue | This information item may indicate the enqueue timing. |
| timing | For example, this information item may include an |
| information | enqueue time indicating the time at which a data packet |
| | is placed into a packet. This timing information may be |
| | shared for one or more frames. For example, it may be |
| | indicated for the HOL packet. Further, this information |
| | may be shared for the traffic of one or more STAs on |
| | the downlink and/or the uplink. For example, STA(s) |
| | may indicate their enqueue timing information to the AP |
| | and the AP may share a set of such timing information |
| | with a neighbor AP. When the AP receives timing |
| | information, it may determine the deadline based on the |
| | enqueue time and a pre-known delay bound information. |
| | The AP may determine the deadline based on knowledge |
| | of QoS setup for the corresponding traffic. |
| Queuing | This information item may indicate the queuing delay |
| delay | information. For example, this information item may |
| information | include a queuing delay which refers to the time a |
| | packet spends waiting in a queue before it can be |
| | transmitted over a network pro processed. This |
| | information may be shared for one or more frames. For |
| | example, it may be indicated for the HOL packet. |
| | Further, this information may be shared for the traffic |
| | of one or more STAs on the downlink and/or the uplink. |
| | For example, STA(s) may indicate their queuing delay |
| | information to the AP and the AP may share a set of |
| | such timing information with a neighbor AP. |
| HOL | This information item may indicate when the time at |
| timing | which a frame reached the head of the line. For example, |
| information | this information item may include an HOL time. This |
| | timing information may also be shared for one or more |
| | frames. Further, this information may be shared for the |
| | traffic of one or more STAs on the downlink and/or the |
| | uplink. For example, STA(s) may indicate their HOL |
| | timing information to the AP and the AP may share a |
| | set of such timing information with a neighbor AP. |
| Expiration | This information item may indicate the expiration timing |
| timing | information. For example, this information item may |
| information | include an expiration time. This timing information may |
| | be shared for one or more frames. For example, it may |
| | be indicated for the HOL packet. Further, this information |
| | may be shared for the traffic of one or more STAs on the |
| | downlink and/or the uplink. For example, STA(s) may |
| | indicate their expiration timing information to the AP |
| | and the AP may share a set of such timing information |
| | with a neighbor AP. |
| Timer | This information item may indicate one or more timers |
| information | (instead of time) to enable the AP to assess if the frame |
| | has expired or not. For example, this information item |
| | may include an expiration timer. This timing information |
| | may be shared for one or more frames. For example, it |
| | may be indicated for the HOL packet. Further, this |
| | information may be shared for the traffic of one or more |
| | STAs on the downlink and/or the uplink. For example, |
| | STA(s) may indicate their timing information to the AP |
| | and the AP may share a set of such timer information |
| | with a neighbor AP. |
| Delay | This information item may indicate the amount of time |
| bound | after which the frame may be considered to be expired. |
| information | For example, this information item may include a delay |
| | bound value. This timing information may be shared for |
| | one or more frames. For example, it may be indicated for |
| | the HOL packet. Further, this information may be shared |
| | for the traffic of one or more STAs on the downlink and/ |
| | or the uplink. For example, STA(s) may indicate their |
| | delay bound information to the AP and the AP may share |
| | a set of such timing information with a neighbor AP. |
| Worst case | This information item may describe the worst case timing |
| timing | information. For example, this information item may |
| information | include an enqueue time for the frame that has stayed in |
| | the queue for the longest period of time or the HOL |
| | frame, the expiry time for the frame that has the earliest |
| | expiration time, etc. Further, this information may be |
| | shared for the traffic of one or more STAs on the |
| | downlink and/or the uplink. For example, STA(s) may |
| | indicate their timing information to the AP and the AP |
| | may share a set of such worst case timing information |
| | with a neighbor AP. |
| Average | This information item may describe the average timing |
| timing | information. For example, this information item may |
| information | include an average queuing delay for all the frames in |
| | that transmission. Further, this information may be |
| | shared for the traffic of one or more STAs on the |
| | downlink and/or the uplink. For example, STA(s) may |
| | indicate their average timing information to the AP and |
| | the AP may share a set of such timing information with |
| | a neighbor AP |
| Best case | This information item may describe the best case timing |
| timing | information. For example, this information item may |
| information | include the best case queuing delay across all the frames |
| | in that transmission. Further, this information may be |
| | shared for the traffic of one or more STAs on the |
| | downlink and/or the uplink. For example, STA(s) may |
| | indicate their best case timing information to the AP and |
| | the AP may share a set of such timing information with |
| | a neighbor AP |
| Variation | This information item may describe the variation for |
| information | various timing information across all the frames in the |
| | transmission. For example, this information item may |
| | include a variation for queuing delay computed over all |
| | the frames in that transmission. Further, this information |
| | may be shared for the traffic of one or more STAs on the |
| | downlink and/or the uplink. For example, STA(s) may |
| | indicate their variation information to the AP and the AP |
| | may share a set of such timing information with a |
| | neighbor AP. |
| Timing | This information item may describe the timing |
| information | information over the past transmissions for the same |
| based on | category of frames. For example, this information |
| past data | item may include average and/or best and/or worst |
| | case queuing delay across all the frames transmitted in |
| | that category in the past. Any of the above metrics may |
| | also be used instead of queuing delay. Further, this |
| | information may be shared for the traffic of one or |
| | more STAs on the downlink and/or the uplink. For |
| | example, STA(s) may indicate their past timing |
| | information to the AP and the AP may share a set of |
| | such timing information with a neighbor AP. |
| Measure- | This information item may describe the window over |
| ment | which the timing information may be collected. This |
| window | measurement window may also be negotiated |
| | between the two devices beforehand or may be |
| | a predetermined value. For example, the |
| | predetermined value may be fixed by the specification. |
| | Further, this information may be shared for the traffic of |
| | one or more STAs on the downlink and/or the uplink. For |
| | example, STA(s) may indicate their timing information |
| | to the AP and the AP may share a set of such |
| | measurement window information with a neighbor AP. |

In some embodiments, the information items shown in Table 5 may be conveyed in a number of different formats. For example, they may be conveyed in the unit of TUs or any other unit providing finer resolution.

In some embodiments, the above information items shown in Table 5 may be transmitted together or separately. In some embodiments, they may be transmitted as a part of any existing frame/element/field/subfield in the Standard or may be a part of newly defined ones.

In some embodiments, the timing information sharing message may contain at least one or more of information items as indicated in Table 6. Table 6 shows information items that can be present in the timing information sharing message.

TABLE 6

| Information | |
|---|---|
| items | Description |
| Timing | This information item may convey the timing information |
| information | of the first AP to the second AP. Examples are |
| | described in Table 5. This may also be a list of timing |
| | information. |
| Direction | This information item may convey the direction of the |
| indication | timing information item. For example, this information |
| | item may indicate downlink, uplink, peer to peer, |
| | etc. as the direction of the timing information. |
| Duration | This information item may indicate the amount of time |
| information | that is needed for the transmission. |
| Traffic | This information item may indicate the type of traffic |
| type | that the timing information can be indicated for. For |
| | example, this information item may include a traffic |
| | identifier (TID), an access category (AC), or both. |
| STA | This information item may indicate the STA(s) for |
| information | which the information can be indicated. For example, |
| | this information item may include a list of STA MAC |
| | addresses. |
| Reason | This information item may indicate the reason for |
| information | sharing the timing information. For example, this |
| | information item may indicate the reason |
| | for making a resource request. |

In some embodiments, the above information items shown in Table 6 may be transmitted together or separately. In some embodiments, they may be transmitted as a part of any existing frame/element/field/subfield in the Standard or may be a part of newly defined ones.

Hereinafter, a negotiation procedure for timing information sharing in the multi-network will be described.

According to one embodiment, there may be a negotiation between the AP stations about timing information sharing. For instance, one of the AP stations may transmit a request message to initiate a setup for the timing information sharing. In some embodiment, referring to FIG. 13, the shared AP 31 may transmit a request message to initiate a setup for the timing information sharing and the sharing AP 31 may transmit a response message in response to the request message. In some embodiment, referring to FIG. 13, the sharing AP 32 may transmit a request message to initiate a setup for the timing information sharing and the shared AP 32 may transmit a response message in response to the request message.

The request message may contain at least one or more of the information items as indicated in Table 7. Table 7 shows information items that can be present in the negotiation request message.

TABLE 7

| Information | |
|---|---|
| item | Description |
| Reason | This information item may indicate the reason to |
| information | transmit the message. For example, this information |
| | item may include a reason code. |
| Reference | This information item may serve as a reference for the |
| information | request message. For example, this information item |
| | may include a dialog token. |
| Duration | This information item may indicate the duration for |
| information | which the information can be considered as valid. For |
| | example, this information item may include a deadline. |
| AP | This information item may identify the requesting AP. |
| identifier | For example, this information item may include an |
| | AP MAC address. |
| BSS | This information item may identify the BSS. For |
| identifier | example, this information item may include a BSSID. |
| AP load | This information item may indicate the load on the |
| information | current AP. For example, this information item may |
| | include the number of STAs, their cumulative or |
| | individual traffic load, etc. |

In some embodiments, the above information items shown in Table 7 may be transmitted together or separately. In some embodiments, they may be transmitted as a part of any existing frame/element/field/subfield in the Standard or may be a part of newly defined ones.

Upon receiving a request message, the AP may process the request message and generate a response message. The response message may contain at least one or more of the information items as indicated in Table 8. Table 8 shows information items that can be present in the negotiation response message.

TABLE 8

| Information | |
|---|---|
| item | Description |
| Reference | This information item may indicate the request message |
| information | to which the response message can correspond to. For |
| | example, this information item may include a dialog |
| | token. |
| Status | This information item may indicate the status of the |
| information | request message. For example, this information item |
| | may include a status code. |

In some embodiments, the above information items shown in Table 8 may be transmitted together or separately. In some embodiments, they may be transmitted as a part of any existing frame/element/field/subfield in the Standard or may be a part of newly defined ones.

In some embodiments, a negotiation may not be necessary, and transmission of the timing information itself may be sufficient.

Hereinafter, a capability indication procedure will be described.

An AP station that can request and/or provide such a timing information exchange may advertise the capability in one or more frames that it transmits. For example, to advertise the capability, management frames such as beacons, probe response, etc. may be used. Example parameters that can be used to make such an indication may be bit/flag which can take a predetermined value to make the indication. This indication may help the STAs to understand the capabilities of the AP stations and associate with such APs if desirable. For instance, an STA may have traffic requiring low latency and may prefer to associate with an AP that has such a timing information sharing support. The STA may understand the AP's capability based on the AP's advertisement.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the disclosure. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems may generally be integrated together in a single software/hardware product or packaged into multiple software/hardware products.

The disclosure is provided to enable any person skilled in the art to practice the various aspects described herein. In some instances, well-known structures and components are shown in block diagram form to avoid obscuring the concepts of the subject technology. The disclosure provides myriad examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, the detailed description provides illustrative examples, and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An electronic apparatus, comprising:
a memory; and
a processor operably coupled to the memory and supporting a first non-AP station, the processor configured to cause:
generating timing information indicating when a packet is expired,
transmitting the packet to a first access point (AP) which the first non-AP station is associated with, and
transmitting the timing information to the first AP to enable the first AP to transmit the packet based on the timing information to a second non-AP station associated with the first AP or to enable the first AP to transmit the packet based on the timing information to a second AP so that the second AP transmits the packet to a third non-AP station associated with the second AP.

2. The electronic apparatus of claim 1, wherein the timing information includes at least one of enqueue time indicating a time at which the packet is placed into a queue, a queuing delay indicating a time which the packet spends waiting in a queue before being transmitted, head-of-line (HOL) timing information indicating a time at which the packet reached the head of a queue, an expiration time indicating when the packet is expired, an expiration timer indicating time intervals after which the frame can be considered to be expired, and an information item indicating the amount of time after which the frame can be considered to be expired.

3. The electronic apparatus of claim 1, wherein the processor is further configured to cause:
receiving a solicitation message to request the timing information from the first AP, and
transmitting the timing information to the first AP in response to the request.

4. The electronic apparatus of claim 3, wherein the solicitation message includes at least one of an information item indicating a traffic stream for which the timing information is being requested, an information item indicating a traffic category for which the timing information is being requested, an information item indicating a time window over which the timing information can be collected, an information item indicating that raw timing information is being requested instead of a cumulative statistic timing information, an information item indicating a reason for requesting the timing information, an information item indicating a dialog token serving as a reference of the solicitation message, and an information item indicating a device which is requested to provide the timing information.

5. The electronic apparatus of claim 1, wherein the processor is further configured to cause:
receiving capability information indicating whether the first AP is able to process the packet based on the timing information, from the first AP.

6. The electronic apparatus of claim 1, wherein the processor is further configured to cause:
transmitting capability information indicating whether the electronic apparatus is able to provide the timing information, to the first AP.

7. The electronic apparatus of claim 1, wherein the processor is further configured to cause:
transmitting a need indication message including a need indication requesting the first AP to process a packet transmitted by the electronic apparatus based on the timing information, to the first AP.

8. The electronic apparatus of claim 7, wherein the need indication message further includes at least one of an information item indicating a duration for which processing indicated by the need indication is needed, an information item indicating a device for which processing indicated by the need indication is needed, an information item indicating traffic stream for which processing indicated by the need indication is needed, and an information item indicating traffic category for which processing indicated by the need indication is needed.

9. The electronic apparatus of claim 1, wherein the packet and the timing information is included in the same frame.

10. The electronic apparatus of claim 1, wherein the timing information and the packet are transmitted in separate frames.

11. A method performed by an electronic apparatus including a first non-access-point (non-AP) station, comprising:
generating timing information indicating when a packet is expired;
transmitting the packet to a first access point (AP) which the first non-AP station is associated with; and
transmitting the timing information to the first AP to enable the first AP to transmit the packet based on the timing information to a second non-AP station associated with the first AP or to enable the first AP to transmit the packet based on the timing information to a second AP so that the second AP transmits the packet to a third non-AP station associated with the second AP.

12. The method of claim 11, wherein the timing information includes at least one of enqueue time indicating a time which the packet is placed into a queue, a queuing delay indicating a time which the packet spends waiting in a queue before being transmitted, head-of-line (HOL) timing information indicating a time at which the packet reached the head of a queue, an expiration time indicating when the packet is expired, an expiration timer indicating time intervals after which the frame can be considered to be expired, and an information item indicating the amount of time after which the frame can be considered to be expired.

13. The method of claim 11, further comprising:
receiving a solicitation message to request the timing information from the first AP, and
wherein the timing information is transmitted to the first AP in response to the request.

14. The method of claim 13, wherein the solicitation message includes at least one of an information item indicating a traffic stream for which the timing information is being requested, an information item indicating a traffic category for which the timing information is being requested, an information item indicating a time window over which the timing information can be collected, an information item indicating that raw timing information is being requested instead of a cumulative statistic timing information, an information item indicating a reason for requesting the timing information, an information item indicating a dialog token serving as a reference of the solicitation message, and an information item indicating a device which is requested to provide the timing information.

15. The method of claim 11, further comprising:
receiving capability information indicating whether the first AP is able to process the packet based on the timing information, from the first AP.

16. The method of claim 11, further comprising:
transmitting capability information indicating whether the electronic apparatus is able to provide the timing information, to the first AP.

17. The method of claim 11, further comprising:
transmitting a need indication message including a need indication requesting the first AP to process a packet transmitted by the electronic apparatus based on the timing information, to the first AP.

18. The method of claim 17, wherein the need indication message further includes at least one of an information item indicating a duration for which processing indicated by the need indication is needed, an information item indicating a device for which processing indicated by the need indication is needed, an information item indicating traffic stream for which processing indicated by the need indication is needed, and an information item indicating traffic category for which processing indicated by the need indication is needed.

19. The method of claim 11, wherein the packet and the timing information is included in the same frame.

20. The method of claim 11, wherein the timing information and the packet are transmitted in separate frames.
